(19) United States
(12) Patent Application Publication
(10) Pub. No.: US 2009/0051077 A1
(43) Pub. Date: Feb. 26, 2009

(54) Apparatus and method for molding plastics having relief decoration

(75) Inventor: Chun-Yuan Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/953,868

(22) Filed: Dec. 11, 2007

(30) Foreign Application Priority Data
Aug. 22, 2007 (CN) 200710201433.3

(51) Int. Cl. B29C 45/16; B29C 45/04; B29C 45/34

(52) U.S. Cl. 264/266; 425/112

(57) ABSTRACT

An apparatus for molding plastics having relief decorations includes a mold and a transport. The mold defines a cavity therein. The cavity provides a relief pattern area on an inner surface thereof. The transport is used for transporting a foil with a printed layer thereon into the mold, to set the printed layer in position relative to the relief pattern area.

### CROSS-REFERENCE TO RELATED APPLICATIONS

Relevant subject matter is disclosed in a co-pending U.S. patent application Ser. No. (Attorney Docket No. US15156) filed on the same date and entitled “APPARATUS AND METHOD FOR MOLDING PLASTICS HAVING RELIEF DECORATION”, which is assigned to the same assignee with this application.

### BACKGROUND

1. Field of the Invention

The present invention generally relates to molding apparatuses and methods. Particularly, the present invention relates to an apparatus and a method for molding plastics that have relief decorations.

2. Description of Related Art

Plastics are widely used in peoples' daily life. Some plastics generally have decorative patterns thereon for artistry and beauty. Commonly, after the plastics are molded, the decorative patterns are merely painted on the surfaces of the plastics, and so are easily worn away over time.

An In-Mold-Decoration (IMD) technology is developed to overcome the above defects. The IMD technology incorporates a foil on which decorative patterns are printed. The foil is placed in a cavity bounded by molds. The decorative patterns adhere to the plastic products after the plastics are molded and separated from the cavity, thus forming the decorative patterns on the plastics. However, common IMD technologies can only form planar decorations, but cannot form sculpted relief decorations.

### SUMMARY

In one embodiment, an apparatus for molding plastics having relief decorations includes a mold and a transport. The mold defines a cavity therein. The cavity provides a relief pattern area on an inner surface thereof. The transport is used for transporting a foil with a printed layer thereon into the mold, to set the printed layer in position relative to the relief pattern area.

Other advantages and novel features of the apparatus and method will become more apparent from the following detailed description of preferred embodiments when taken in conjunction with the accompanying drawings, in which:

### BRIEF DESCRIPTION OF THE DRAWINGS

FIG. 1 is a disassembled, cross-sectional view of an apparatus for molding plastics having relief decorations in accordance with an exemplary embodiment of the present invention;

FIG. 2 is an assembled, cross-sectional view of FIG. 1;

FIG. 3 is similar to FIG. 2, but showing an injection view; and

FIG. 4 is a flow chart of a method for molding plastics having relief decorations in accordance with an exemplary embodiment of the present invention.

### DETAILED DESCRIPTION

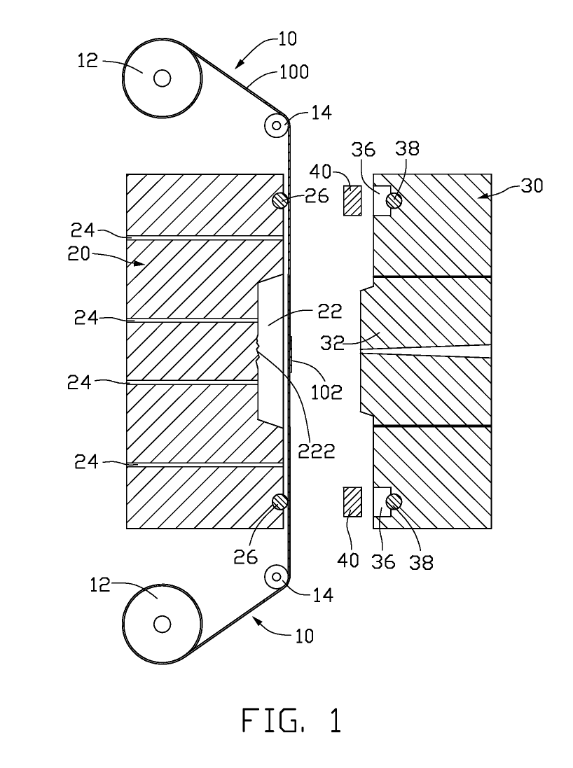

Referring to FIG. 1, an apparatus for molding plastics having relief decorations in accordance with an embodiment of the present invention includes a transport 10, a mold including a female mold 20 and a male mold 30, and a pressing member 40.

The transport 10 includes two transporting rollers 12 and two guiding rollers 14 positioned at two opposite ends of the mold, respectively, for transporting a foil 100 into the mold between the female and male molds 20, 30.

The foil 100 includes a base (not labeled) and a printed layer 102 attached to the base. The base of the foil 100 is made of macromolecule materials such as polycarbonate (PC) or polybutylene terephthalate (PBT). The printed layer 102 can be an ink layer when used in In-Mold-Roller (IMR) technology, or an adhering layer with an ink layer printed thereon when used in In-Mold-Label (IML) technology.

The female mold 20 defines a cavity 22 in a first side thereof facing the male mold 30, and a relief pattern area 222 is formed from a bottom of an inner surface of the cavity 22. The relief pattern area 222 can be formed by various technologies, such as an etching technology. The female mold 20 defines a plurality of air discharging holes 24 extending from the first side, facing the male mold 30, of the female mold 20 to a second side opposite to the male mold 30. At least one of the air discharging holes 24 is communicated with the cavity 22. A vacuum-pump (not shown) is connected to the second ends of the air discharging holes 24, for discharging air from the cavity 22. A plurality of hermetic rings 26 is attached to the female mold 22 around the cavity 22.

The male mold 30 includes a projection portion 32 protruding towards the female mold 20 corresponding to the cavity 22. The male mold 30 defines an injection opening (not labeled) extending from a side, facing the female mold 20, thereof to the other side thereof. A slot 36 is defined in the male mold 30, around the projection portion 32 facing the female mold 20. A plurality of hermetic rings 38 are received in a bottom of the slot 36.

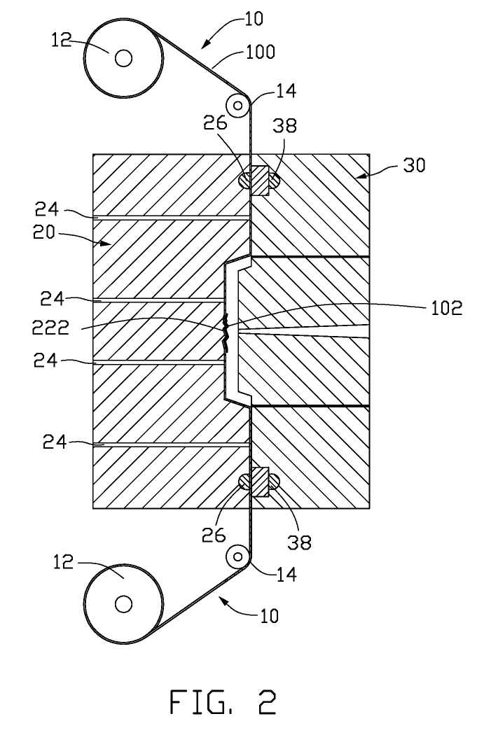

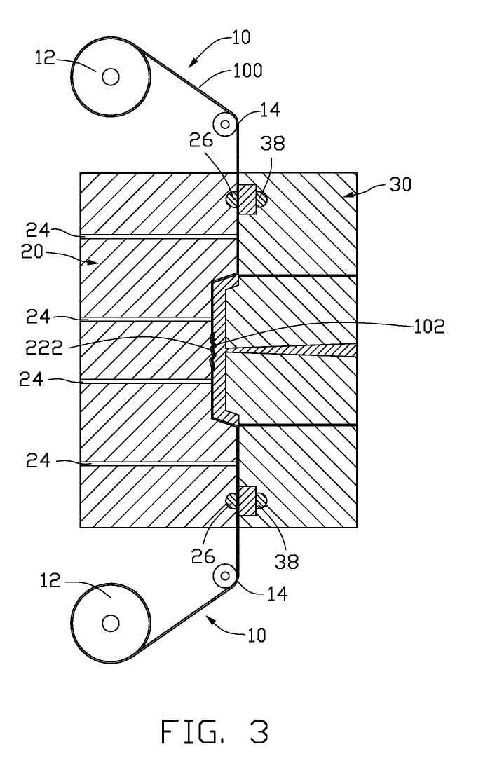

Referring to FIGS. 2 and 3, in use, the transport 10 transports the foil 100 into the mold between the female mold 20 and the male mold 30, and the printed layer 102 is set in position relative to the relief pattern area 222. The male mold 30 is clamped to the female mold 20, with the pressing member 40 being received in the slot 36 and tightly pressing the foil 100 on the female mold 20 and resisting against the hermetic rings 26, 38. The vacuum-pump discharges the air from a space bounded by the foil 100 and the inner surface of the cavity 22 through the air discharging holes 24, making the foil 100 tightly attached on the inner surface of the cavity 22. Molten resin is injected into a molding space bounded by the foil 100 and the male mold 30 through the injection opening. The molten resin is cooled to form a plastic, with relief decorations formed on a surface thereof due to the relief pattern area 222 of the cavity 22 and the printed layer 102 of the foil 100. After the male mold 30 is separated from the female mold 20, the plastic is removed from the molding space. The printed layer 102 is separated from the base of the foil 100 to be adhered to the plastic. The transport 10 is operated to transport the remaining base of the foil 100 to move out of the mold, and move another foil 100 in.

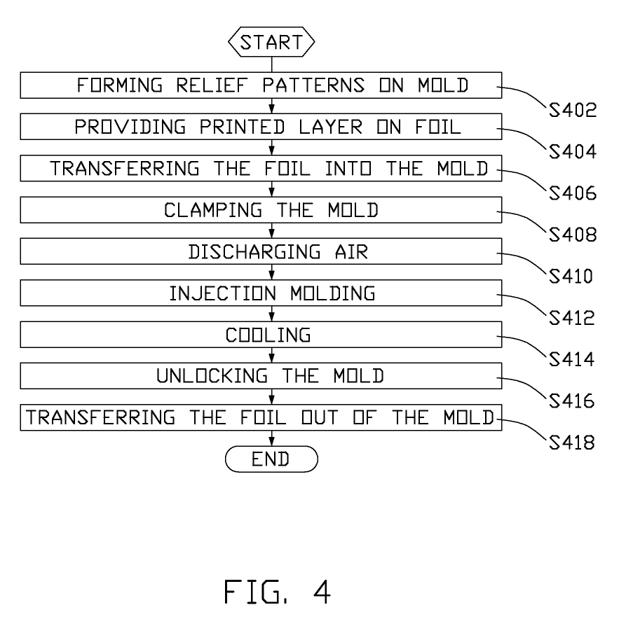

Referring to FIG. 4, a method for molding plastics having relief decorations in accordance with an exemplary embodiment includes the following steps.

Step S402, forming the relief pattern area 222 on the inner surface of the cavity 22 defined in the female mold 20.

Step S404, providing a printed layer 102 on the base of the foil 100.

Step S406, the transport 10 transports the foil 100 with the printed layer 102 into the mold between the female mold 20 and the male mold 30, and the printed layer 102 is set in position relative to the relief pattern area 222 of the female mold 20.

Step S408, clamping the male mold 30 with the female mold 20, and pressing the foil 100 on the female mold 20 with a pressing member 40 being received in the slot 36 of the female mold 20. Thus, a space is formed between the foil 100 and the inner surface of the cavity 22.

Step S410, discharging the air from the space through the air discharging holes 24 extending in the female mold 20 from the surface thereof on which the cavity 22 is defined to the other surface thereof. Therefore, the foil 100 is tightly attached to the inner surface of the cavity 22.

Step S412, injecting molten resin into a molding space bounded by the foil 100 and the male mold 30 through the injection opening extending in the male mold 30 from the surface thereof facing the female mold 20 to the other surface thereof. The injection of the molten resin continues until the molten resin fills the molding space.

Step S414, cooling the molten resin in the molding space.

Step S416, unlocking the mold to separate the male mold 30 from the female mold 20. The molded plastic having relief decorations thereon is removed from the mold with the printed layer 102, which was previously provided on the base of the foil 100 adhering on the surface of the relief decorations. Therefore, a plastic workpiece is formed with relief decorations thereon.

Step S418, the transport 10 transports the remaining base of the foil 100 out of the mold, and returns to step S406.

The apparatus and method for molding relief decorations provides the relief patterns on the inner surface of the molding space, and the printed layer being set in position relative to the relief patterns, therefore the molded product is formed with the relief decoration. The relief decoration is firmly and durably formed on the molded product.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An apparatus for molding plastics having relief decorations, comprising:
a mold defining a cavity therein, the cavity providing a relief pattern area on an inner surface thereof; and
a transport for transporting a foil with a printed layer thereon into the mold, to set the printed layer in position relative to the relief pattern area.

2. The apparatus as described in claim 1, wherein the mold comprises a male mold and a female mold, the cavity is defined in the female mold, and the foil is transported into the mold between the male mold and the female mold.

3. The slide rail as described in claim 1, wherein the printed layer is an ink layer printed on a base of the foil.

4. The apparatus as described in claim 1, wherein the printed layer is an adhere layer attached to a base of the foil with ink printed thereon.

5. The apparatus as described in claim 1, wherein the mold defines at least one discharge hole, for discharging air from a space bounded by the foil and the mold.

6. The apparatus as described in claim 1, wherein the mold comprises a pressing member for pressing the foil on the mold.

7. The apparatus as described in claim 6, wherein the mold further defines a slot for receiving the pressing member.

8. The apparatus as described in claim 7, wherein at least a hermetic ring is received in the slot, for being pressed by the pressing member.

9. A method for molding plastics having relief decorations, comprising steps of:
providing a mold defining a cavity therein, a relief pattern area being formed on an inner surface of the cavity;
transporting a foil having a printed layer into the mold, and setting the printed layer in position relative to the relief pattern area; and injection molding.

10. The method as described in claim 9, further comprising discharging air from a space bounded by the foil and the mold.

11. The method as described in claim 9, further comprising opening the mold and separating a base that the printed layer printed thereon of the foil, therefore allowing the printed layer to be adhered on a molded plastic.
